(19) United States
(12) Patent Application Publication
(10) Pub. No.: US 2012/0188141 A1
(43) Pub. Date: Jul. 26, 2012

(54) MILTIRESONANCE ANTENNA AND METHODS

(76) Inventor: Muhammad Nazrul Islam, Oulu (FI)

(21) Appl. No.: 13/145,555

(22) PCT Filed: Jan. 15, 2010
(86) PCT No.: PCT/FI2010/050017

§ 371 Date: Apr. 12, 2012

(30) Foreign Application Priority Data
Jan. 30, 2009 (FI) 20095085

(51) Int. Cl. H01Q 1/36; H01Q 5/01; H01Q 1/50

(52) U.S. Cl. 343/860; 343/700 MS

(57) ABSTRACT

A multiresonance antenna useful in small-sized radio devices. In one embodiment, radiating element of the antenna comprises, a first and a second radiating arm of nearly equal electric lengths. The tail portions of the arms are located on different sides of the area determined by the outline of the radiator and point to opposite directions away from each other thereby exciting a double resonance in the antenna. The second arm comprises at least one branch extending towards the tail portion of the first arm thereby widening antenna operating band in the frequency range of 900 MHz.

The invention relates to an antenna especially intended for small-sized radio devices, which antenna has more than one resonance for shaping an operating band.

In small-sized radio devices, such as mobile phones, the antenna to be placed inside the device is generally of IFA type (Inverted-F Antenna) or ILA type (Inverted-L Antenna). In both cases the antenna includes a ground plane and a radiating plane parallel with it, to be coupled to the antenna port of the device. In IFA the radiator is also short-circuited to the ground plane from its certain point to arrange the matching. If the radiator is plate-like, the names PIFA (Planar IFA) and PILA (Planar ILA) are used.

In antenna design the available space is a critical factor especially when air is used as the insulator between the radiator and ground plane, which air is advantageous from the point of view of the antenna's efficiency. The distance between the radiator and ground plane has a certain optimum value which, however, is too long to be implemented in a modern, relatively flat radio device in the case of air-insulation. When said distance is decreased, the characteristics of the antenna are degraded. For example the bandwidth, which can be narrow already without this change, reduces. The narrow band is harmful also for the reason that the antenna's resonance frequency is susceptible to the external conductive materials. Therefore, even the hand of a user of the device can cause the shifting of the operating band of the antenna partly outside the frequency range in which the spectrum of the signal is located.

One way to widen the operating band of the antenna is to arrange for it at least two resonance frequencies relatively close to each other. This is usually implemented by means of two separate radiating elements, which then have almost the same resonance frequency. One element is parasitic, receiving in the transmitting state its energy through the main element, which is fed directly. A disadvantage of the use of a parasitic element is that already a minor change in the mutual location of it and the main element significantly degrades the band characteristics of the antenna. In addition, the parasitic element requires a short-circuit arrangement of its own.

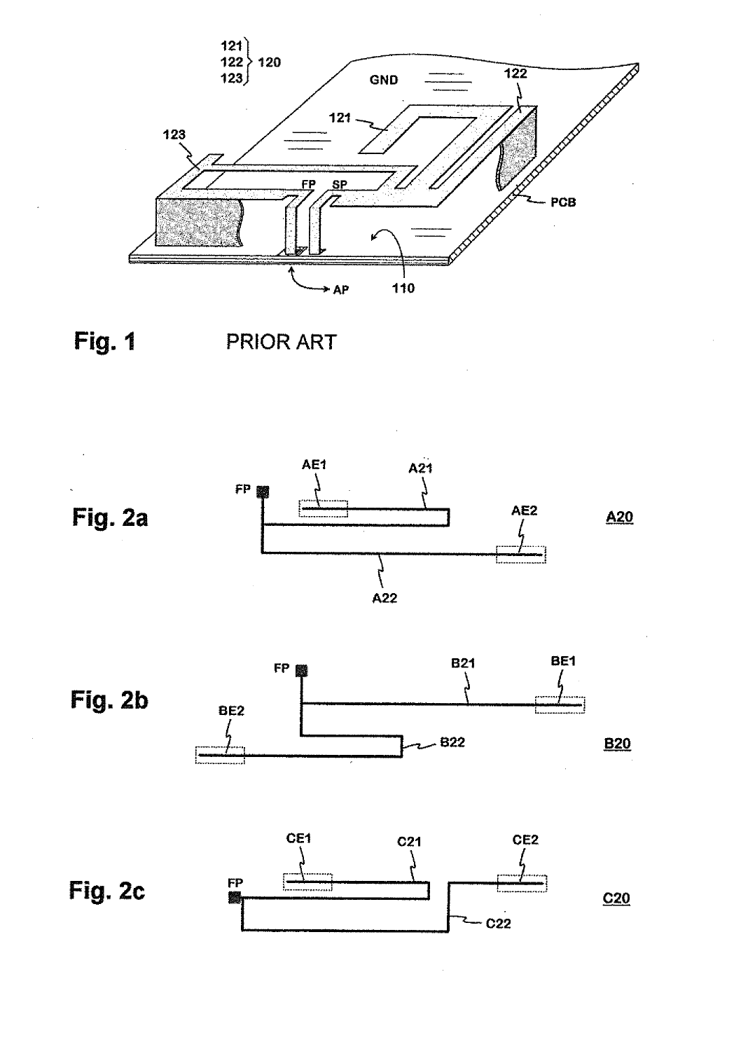

FIG. 1 shows an antenna known from publication EP 1678784, in which two resonances being located in the same operating band are implemented by a unitary radiating element. The antenna is a dual-band one, the lower band being in the range of 900 MHz and the upper band below 2 GHz. The conductive upper surface of the circuit board PCB of the radio device functions as the antenna's ground plane 110, which is a part of the signal ground GND. Above the ground plane there is the radiating plane 120 of the antenna. On a side of the radiating plane there are, close to each other, the antenna feed point FP connected to the antenna port AP and the short-circuit point SP connected to the ground plane. The side in question of the radiating plane is here called ‘front side’. The radiating plane comprises, as viewed from the short-circuit point SP, two conductor arms of different lengths, which form a PIFA part of the antenna together with the ground plane. The first arm 121 extends from the short-circuit point to the opposite side of the radiating plane and finally turns back towards the front side. The second arm 122 extends to the opposite side of the radiating plane beside the first arm, forming one end of the radiating plane. The radiating plane also comprises a conductor loop 123 being located on its front side. The end points of the loop are the above-mentioned feed and short-circuit points. When starting from the feed point FP, the loop joins the rest of the radiating plane at the starting part of the first arm 121 relatively close to the short-circuit point SP. In fact, this joining point is the feed point of the PIFA part of the antenna.

The resonance frequency of the antenna part corresponding to the first arm 121 is located in the lower operating band of the antenna, which is wholly based on the first arm. The resonance frequency of the antenna part corresponding to the second arm 122 again is in the upper operating band of the antenna. In addition, the loop 123 is dimensioned so that it resonates and functions as a radiator in the upper operating band of the antenna. Thus the upper operating band is based on both the second arm and the loop. The resonance frequencies corresponding to these parts are e.g. 1.8 GHz and 1.95 GHz, in which case the upper operating band becomes wide. This succeeds, because the first conductor arm of the radiating plane is located between the conductor loop and the second conductor arm, in which case the coupling between the last two is relatively weak. The loop part of the radiating plane functions, besides as a radiator, also as a matching element at the frequencies of the lower operating band.

A disadvantage of the solution described above is that arranging a double resonance according to it in the operating band, which is located in the range of 900 MHz, to widen that band requires space and can not take place in a small radio device.

It is also known to add a reactive circuit outside the radiator to the antenna structure, by means of which circuit the antenna can be made to resonate at two frequencies close to each other. However, the extra components require space and increase the production costs of the device.

An object of the invention is to reduce said disadvantages related to prior art. A multiresonance antenna according to the invention is characterized by what is set forth in the independent claim 1. Some advantageous embodiments of the invention are disclosed in the dependent claims.

The basic idea of the invention is as follows: The radiating element of the antenna of a radio device comprises, viewed from its feed point, a first and a second arm with nearly equal electric lengths. The tail ends of the arms are located on different sides of the area confined by the outline of the radiating element and point to substantially opposite directions away from each other for exciting a double resonance in the antenna. The second arm has at least one extension towards the tail portion of the first arm.

An advantage of the invention is that an operating band of the internal antenna of a radio device can be widened by means of an extra resonance without an extra element. This succeeds also in the band in the range of 900 MHz of a multiband antenna. Another advantage of the invention is that the solution according to it is simple also in other respects and hardly causes rise in the production costs.

The invention is below described in detail. In the description it will be referred to the accompanying drawings where

FIG. 1 shows an example of the multiresonance antenna according to the prior art,

FIGS. 2a-c show possible radiator forms as introduction to the invention,

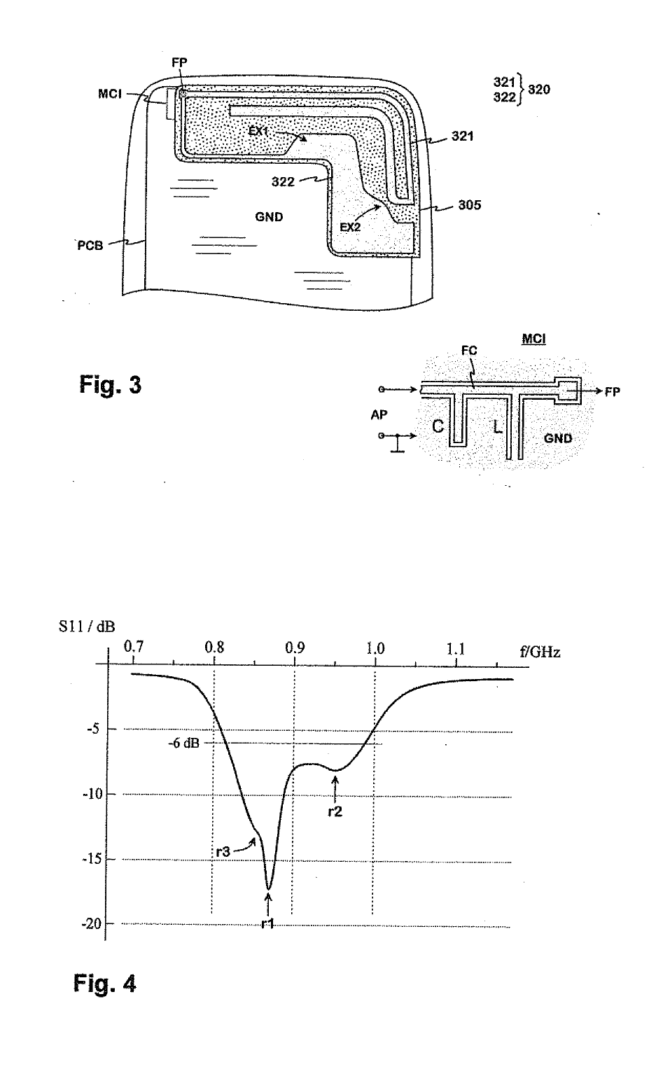

FIG. 3 shows an example of the antenna according to the invention,

FIG. 4 shows the band characteristics of the antenna according to FIG. 3,

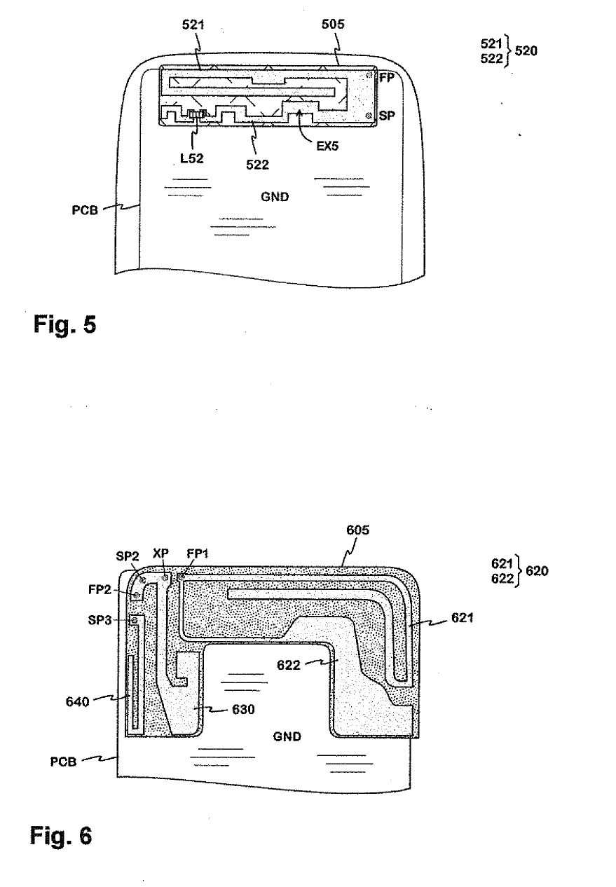

FIG. 5 shows another example of the antenna according to the invention,

FIG. 6 shows a supplement of the antenna according to FIG. 3, and

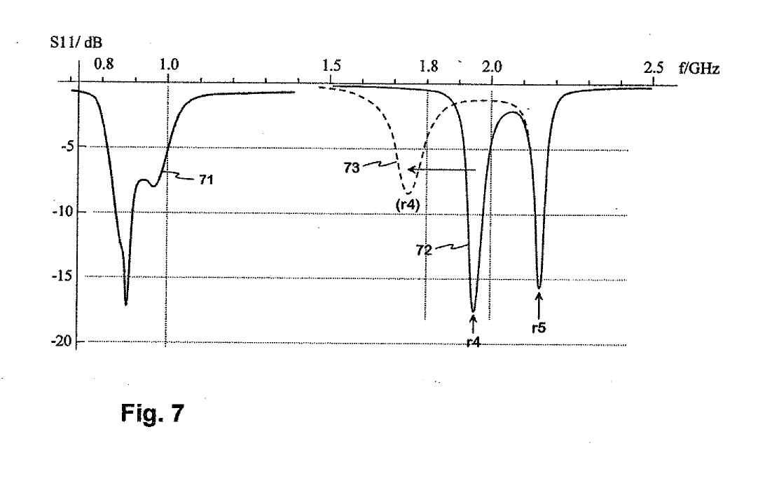

FIG. 7 shows the band characteristics of the antenna according to FIG. 6.

FIG. 1 was already described in conjunction with the description of the prior art.

FIGS. 2a-c show possible radiator forms as introduction to the invention. In all examples the radiator comprises two arms viewed from the feed point, and the outline of the radiator forms an elongated area, which then has a longitudinal direction and a transverse direction. In FIG. 2a the feed point FP of the radiator is located at one end of the area formed by the outline of the radiator, in a corner of this area. The arms of the radiator have first a relatively short transverse shared portion when starting from the feed point FR In the first arm A21 there is after the shared portion a longitudinal first portion, a U-shaped bend and a longitudinal tail portion. The tail portion extends relatively close to the starting end of the arm and the feed point FR In the second arm A22 there is, as a continuation of the shared portion, a transverse first portion and a longitudinal second portion, which extends by the bend of the first arm farther from the feed point.

In FIG. 2b the first arm B21 of the radiator B20 is longitudinal in its entirety. In the second arm B22 of the radiator there is, as a continuation of the shared portion of the arms, a transverse first portion, a second portion to the same direction as the first arm, a U-shaped bend and a longitudinal third portion, which extends a certain distance by of the transverse first portion.

In FIG. 2c the first arm C21 of the radiator C20 has a longitudinal first portion, a U-shaped bend and a longitudinal tail portion, which extends relatively close to the starting end of the arm and the feed point FP. The second arm C22 has a transverse first portion away from the area of the first arm, a longitudinal second portion which extends by the bend of the first arm farther from the feed point, a third portion which extends in the transverse direction to the line of the tail end of the first portion and a longitudinal fourth portion away from the feed point and the first arm.

Consistent with the description above, in each case 2a-c the tail end AE1, BE1, CE1 of the first arm and the tail end AE2, BE2, CE2 of the second arm are directed to the opposite directions away from each other so that they and their continuation lines do not overlap, viewed in the perpendicular direction of the tail ends. The ‘tail end’ of an arm means a relatively short portion of the arm, which ends to the open head of the arm. ‘Relatively short’ again means an order of 10-20%. The radiator structure shall not be confused with the dipole, the arms of which are wholly separate and coupled to the terminals with opposite phases of the feeding source.

The radiator has two arms to excite two resonances in the antenna, which is customary as such. In the antenna according to the invention the electric lengths of the radiator arms are so close to each other that the resonances corresponding to them constitute a continuous, relatively wide operating band for the antenna. This succeeds also in the frequency range of 900 MHz, or in the lower operating band of a usual mobile terminal, by means of the arrangement described above. In practice, arranging the double resonance in question in the lower operating band has been more difficult than in the upper operating band.

The feed point FP is marked in the radiator in FIGS. 2a-c. The radiator can also have a short-circuit point close to the feed point if it benefits the antenna matching. Generally it can be said that the radiator has two arms viewed from the feed area, where ‘feed area’ means the part of the radiator in which both the feed and the short-circuit point are, or bare feed point is located.

FIG. 3 shows an example of the antenna according to the invention. The antenna comprises the radiator 320 and the ground plane. The radiator 320 is in this example of conductive coating of a small dielectric plate 305, which is supported at a height of e.g. 5 mm from the circuit board PCB of a radio device. The upper surface of the circuit board is mostly of conductive signal ground GND, which functions as the ground plane of the antenna at the same time. The dielectric plate 305 is in this example about a rectangle by shape, one corner of which lacks a rectangular part so that the first end of the plate is shorter than the second end and the plate has only one straight long side. Instead of the second long side there is a step-shaped edge, which then forms an inner corner in the plate 305. The outline of the radiator follows the edges of the dielectric plate 305. The area confined by the outline, or the radiator area, then has the longitudinal direction in the direction of the long side of the plate and the transverse direction perpendicular to the longitudinal direction. The feed point FP of the radiator is located in a corner of the dielectric plate on the side of the first end. The radiator comprises two arms starting from the feed point. In the first arm 321 there is a first portion starting to the longitudinal direction from the feed point and turning to the transverse direction at the second end, a U-shaped bend towards the centre of the plate and a tail portion, which travels beside the first portion extending longitudinally relatively close to the feed point. In the second arm 322 there is a transverse first portion starting from the feed point FP and a second portion, which follows said step-shaped edge of the plate 305. The second arm extends at its tail end longitudinally to the second end of the radiator area.

Consistent with the description above, the tail end of the first arm 321 of the radiator is directed towards the first end of the radiator area, in the figure the left end, and the tail end of the second arm 322 is directed towards the second end of the radiator area, in the figure the right end. The tail ends are directed away from each other so that their continuation lines do not overlap when viewed in the transverse direction. In addition, the tail ends of the arms are on different sides of the radiator area so that if this area is divided into four blocks by the longitudinal and transverse straight lines going through its centre, the tail ends of the arms are located in the opposite blocks.

The width especially of the second arm 322 of the radiator varies. At the starting end, near the feed point FP, the arm is relatively narrow. About at the inner corner of the dielectric plate the second arm has an extension EX1 so that its distance to the tail portion of the first arm decreases significantly. This means a stronger electromagnetic coupling between the arms at the place in question. The second arm continues relatively broad as far as its open end. Near this open end the second arm has an additional extension EX2, which strengthens the coupling between the arms at the U-shaped bend of the first arm. At the extensions EX1 and EX2 the coupling between the arms is mainly capacitive because of their locations. Broadening of the second arm has an effect, which widens the operating band of the antenna. Strengthening the capacitive coupling between the arms again increases their electric size and helps then to implement an antenna, which operates in a determined band, in a smaller space. The narrowness of the radiating arm close to the feed point provides the same benefit, because it means a higher inductance there and thus a larger electric size.

FIG. 3 shows also an example of the matching circuit of the antenna according to the invention. The matching circuit MCI of the example is a conductor pattern on the surface of the circuit board PCB of the radio device. Its structure is seen in the auxiliary drawing in FIG. 3. A feed conductor FC connected to the antenna port AP of the device constitutes, together with the ground plane GND surrounding the feed conductor on both sides, a planar transmission line, which is the feed line of the antenna. From the feed line branches a planar transmission line, which is shorter than a quarter wave and open at the tail end, and at another point a planar transmission line, which is shorter than a quarter wave and short-circuited at the tail end. Thus the former line represents at an operating frequency a certain parallel capacitance C and the latter line a certain inductance L for the feed line. The feed conductor FC continues as a short intermediate conductor to the feed point FP. By choosing the length of the feed line and the location and length of the branching transmission lines suitably, the antenna impedance measured at the antenna port becomes at least nearly nominal in the range of the operating band. In addition, a third useful resonance for widening the operating band in question can be excited in the antenna by means of the matching circuit.

FIG. 4 shows the band characteristics of the antenna according to FIG. 3. The antenna is designed to operate in the frequency range of 900 MHz. The presented curve shows the fluctuation of the reflection coefficient of the antenna as a function of frequency. The operating band is formed on grounds of three resonances of the antenna. The first resonance r1 occurs about at the frequency of 870 MHz, and it is based on the first arm 321 of the radiator. The second resonance r2 occurs about at the frequency of 950 MHz, and it is based on the second arm 322 of the radiator. The third resonance r3 occurs about at the frequency of 850 MHz, and it is based on the matching circuit MCI and the whole radiator 320. The ground plane naturally is a contributory party in all resonances.

Because of several resonances the operating band of the antenna becomes considerably wide. If the value −6 dB of the reflection coefficient is used as criterion for the boundary frequencies of the band, the operating band is about 815-985 MHz. This band covers both the range of 824-894 MHz used by the American GSM system and the range of 880-960 MHz used by the European EGSM system (Extended GSM).

The efficiency in free space of the antenna according to FIG. 3 varies on both sides of the value −3.5 dB in the frequency range of 820-980 MHz.

FIG. 5 shows another practical example of the antenna according to the invention. The antenna comprises the radiator 520 and ground plane GND, which is also in this example of conductive coating of the circuit board PCB of a radio device. The radiator 520 is of conductive coating of a small dielectric plate 505, which is supported at a certain height from the circuit board PCB and thus from the ground plane. The dielectric plate is an elongated rectangle having the first and second end and the longitudinal first and second side. The area confined by the outline of the radiator, or the radiator area, is almost the same as the area of the dielectric plate. The feed point FP of the radiator is located close to the corner defined by the first end and first side of the dielectric plate. In this example the radiator is connected also to the ground plane from the short-circuit point SP. Also this point is located at the first end of the dielectric plate, close to the corner defined by the first end and second side. The area between the feed point and the short-circuit point these points included forms the feed area defined earlier in this description.

The radiator comprises two arms when viewed from the feed area. The first arm 521 starts near the feed point FP. It comprises a longitudinal first portion on the side of the first side of the plate, a U-shaped bend at the second end and a longitudinal tail portion extending relatively close to the feed area. The second arm 522 of the radiator starts near the short-circuit point SP and extends in the longitudinal direction to the second end of the radiator area on the side of the second side. To bring the resonance frequency of the second arm down enough, it comprises small rectangular bends so that the arm resembles a meander pattern. For the same reason there is a coil L52 in series at the tail end of the second arm, and said rectangular bends form extensions, like the extension EX5, towards the first arm 521.

Consistent with the description above, the tail end of the first arm 521 of the radiator is in the half on the side of the first end of the radiator area and is directed towards the first end. The tail end of the second arm 522 again is in the half on the side of the second end of the radiator area and is directed as a whole towards the second end. Thus also in this case the tail ends point to the opposite directions so that they and their continuation lines do not overlap when viewed in the transverse direction. The outermost part of the tail end of the meander-shaped second arm is, however, transversal, pointing away from the U-shaped bend of the first arm. The resonance of the second arm is further a little improved by this detail.

FIG. 6 presents an antenna like the one in FIG. 3 supplemented into an antenna structure, which has two/three operating bands. The antenna structure comprises a radiator 620 according to the invention, which is similar to the one shown in FIG. 3. On the same dielectric plate 605 with it there are a second radiator 630 and a third radiator 640. The second radiator 630 is located next to the side of the radiator 620, where its feed point FP1 is. In the second radiator there are relatively close to each other its feed point, or the second feed point FP2, a short-circuit point SP2 and an adjusting point XP, the last-mentioned being nearest to the feed point FP1 of the radiator 620. The adjusting point can be in a known way coupled to the ground via a switch (not visible). The third radiator 640 is parasitic receiving its energy through the second radiator 630. The third radiator is located on the side of the whole radiator structure so that the second radiator is between it and the radiator 620 according to the invention. The third radiator is short-circuited to the ground GND from its short-circuit point SP3, which is located close to the second feed point FP2.

The antenna structure according to FIG. 6 comprises functionally two antennas, because the second and third radiator together with the ground plane constitute an antenna of its own for the separate feed.

FIG. 7 shows the band characteristics of the antenna structure according to FIG. 6. Curve 71 shows, as a function of frequency, the fluctuation of the reflection coefficient of the part of the antenna structure, which is based on the radiator 620 according to the invention. It is then similar to the curve presented in FIG. 4, shaped by three resonances r1, r2, r3. Curve 72 shows, as a function of frequency, the fluctuation of the reflection coefficient of the supplementary part of the antenna structure based on said radiators 630 and 640, when the adjusting point XP is connected to the ground. The curve includes two distinct resonance points. The fourth resonance r4 occurs about at the frequency of 1950 MHz, and it is based on the second radiator 630. The band corresponding to resonance r4 is located in the frequency range used by the GSM1900 system. The fifth resonance r5 occurs about at the frequency of 2150 MHz, and it is based on the parasitic third radiator 640. The band corresponding to resonance r4 is located in the receiving band of the WCDMA (Wideband Code Division Multiple Access) system, from the point of view of the terminals.

Curve 73 shows, as a function of frequency, the fluctuation of the reflection coefficient of the supplementary part of the antenna structure, when the adjusting point XP is “in the air”, that is, there is a high impedance between it and the ground. Compared with curve 72, the frequency of the fifth resonance holds in its position, but the frequency of the fifth resonance shifts to the point 1740 MHz. The band corresponding to this is located in the frequency range used by the GSM1800 system.

The multiresonance antenna according to the invention has been described before. Its structure may differ from those described in detail. As is seen in the examples of FIGS. 3 and 5, the shape of the radiator may vary greatly. The dielectric plate supporting the radiator may be a part of a small dielectric chamber. The radiator can also be a rigid conductor without any support plate. The ground plane may also extend only partly below the radiator. The structure of the matching circuit of the antenna can naturally vary, and its reactances can be implemented by discrete components in place of transmission lines shown in FIG. 3. The inventional idea can be applied in different ways within the limits defined in the independent claim 1.

1.-11. (canceled)

12. An multiresonance antenna component for implementing an antenna operable in at least a first frequency band, the antenna component having a longitudinal dimension and a transverse dimension, the antenna component comprising:
a feed area having a feed element, the feed element disposed proximate a first corner of the antenna component;
a first radiator electrically coupled to the feed element and configured to effect a first resonance in the first frequency band, the first radiator comprising:
a first branch coupled to the feed point and disposed substantially along the longitudinal dimension;
a second branch disposed substantially parallel to the first branch such that at least a portion of the second branch is proximate the feed area; and
a second radiator configured to effect a second antenna resonance within the first frequency band, the second radiator extending from the feed element towards a second corner of the antenna component.

13. The antenna component of claim 12, wherein the second corner is disposed substantially diagonally from the first corner of the area.

14. The antenna component of claim 13, wherein the second radiator further comprises:
a third branch coupled to the feed element and disposed at least partly along the transverse dimension along a second side;
a fourth branch disposed substantially along the longitudinal dimension; and
at least one extension structure disposed proximate the second branch and configured to increase an electric length of the first radiator and the second radiator.

15. The antenna component of claim 14, wherein the first radiator further comprises a U-shaped branch coupled between the first branch and the second branch and disposed substantially perpendicular to the second branch along a transverse side opposite from the third branch.

16. The antenna component of claim 14, wherein the fourth branch comprises:
a linear segment disposed proximate the third branch; and
a tail segment;
wherein a width of the tail segment exceeds a width of the linear segment as measured in the transverse dimension.

17. The antenna component of claim 16, wherein the tail segment is configured to electromagnetically couple to the second branch, thereby widening said first frequency band.

18. The antenna component of claim 12, further comprising a short-circuit element disposed in the feed area to couple the radiator to a ground plane.

19. The antenna component of claim 18, wherein said second radiator is configured to extend from a location proximate the short-circuit element longitudinally along the second branch.

20. The antenna component of claim 19, wherein the second radiator comprises a meandering element comprising at least two bends configured to increase an electric length of the second radiator, said increased electric length allowing for reduction of at least one dimension of the antenna component.

21. The antenna component of claim 19, wherein the second radiator comprises a series inductor configured to increase an electric length of the second arm.

22. A portable radio device configurable to operate in at least a first frequency band, the device comprising:
an antenna port;
a multiresonance antenna disposed in an area characterized by a longitudinal dimension and a transverse dimension, the antenna comprising:
a feed area having a feed in electrical communication with the antenna port, the feed disposed proximate a first corner of the area;
a first radiator electrically coupled to the feed, the first radiator comprising:
a first branch coupled to the feed and disposed substantially along the longitudinal dimension;
a second branch disposed substantially parallel to the first branch such that at least a portion of the second branch is proximate the feed area; and
the second radiator extending from the feed towards a second corner the area.

23. The portable radio device of claim 22, wherein the first radiator is configured to effect a first antenna resonance in the first frequency band, and the second radiator is configured to effect a second antenna resonance in the first frequency band.

24. The portable radio device of claim 22, further comprising a matching circuit coupled between the antenna port and the feed.

25. The portable radio device of claim 24, wherein the matching circuit is configured to widen the first frequency band by at least partly effecting a third resonance.

26. The portable radio device of claim 22, wherein:
the antenna comprises a conductive coating disposed on a surface of a dielectric substrate; and
the dielectric substrate is spaced a predetermined distance away from a first surface of a printed circuit board (PCB) of the radio device.

27. The portable radio device of claim 26, further comprising a matching circuit coupled between the antenna port and the feed, the matching circuit comprising a conductor element disposed on the first surface.

28. The portable radio device of claim 22, wherein the second corner is disposed diagonally relative the first corner across the area.

29. The portable radio device of claim 28, wherein the second radiator further comprises:
a third branch coupled to the feed and disposed at least partly along the transverse dimension along a second side;
a fourth branch disposed substantially along the longitudinal dimension; and
at least one extension structure disposed proximate the second branch and configured to increase an electric length of the first radiator and electric length of the second radiator.

30. The portable radio device of claim 29, wherein the fourth branch comprises:
a linear segment disposed proximate the third branch; and
a tail segment;
wherein a width of the tail segment exceeds a width of the linear element as measured in the transverse dimension.

31. The portable radio device of claim 22, wherein the first frequency band includes a frequency of 0.9 GHz.

32. The portable radio device of claim 22, wherein the antenna further comprises:
a second feed disposed external to the feed area; and
a third radiator configured to effect radio device operation in a second frequency band.

33. The portable radio device of claim 22, wherein the third radiator comprises a fifth portion coupled to the second feed element and disposed substantially along the transverse dimension.

34. A method of operating an antenna apparatus of a portable radio device in at least a first frequency band, the radio device having an antenna port and a printed circuit board (PCB), and the antenna apparatus having a feed portion with feed element, a first radiator, and a second radiator, the method comprising;
energizing the feed element with a feed signal comprising at least a first component in the first frequency band;
effecting a first resonance in the first frequency band in the first radiator;
effecting a second antenna resonance in the first frequency band in the second radiator; and
effecting a coupling between the second radiator and the first radiator in at least the first frequency band, thereby effecting an increase in an electric length of the first radiator and an electric length of the second radiator.

35. The method of claim 34, wherein said effecting a coupling comprises effecting a coupling between an extension structure of the second radiator and a second branch of the first radiator.

36. An antenna for use in a radio device, comprising:
a ground plane; and
a radiator comprising:
a feed area with a feed point;
a first arm starting from the feed area to excite a first resonance in the antenna; and
a second arm to excite a second resonance in the antenna in an operating band similar to that of the first resonance,
wherein an outline of the radiator forms a radiator area having a longitudinal and transverse direction, characterized in that the first arm comprises:
a first portion starting longitudinally from the feed point;
a U-shaped bend; and
a tail portion which extends longitudinally close to the feed point; and
wherein the second arm extends, as viewed from the feed point, to an opposite side of said radiator area both in a longitudinal and transverse direction, and comprises at least one extension towards the tail portion of the first arm so as to increase the electric length of the arms.

37. An antenna according to claim 36, wherein the second arm comprises a transverse first portion starting from the feed point and a longitudinal second portion, the second portion which is at a tail end thereof substantially broader than at a starting end thereof.

38. An antenna according to claim 36, further comprising a short-circuit point in the feed area of the radiator from which point the radiator is connected to the ground plane.

39. An antenna according to claim 38, wherein said second arm starts from the feed area on a side of the short-circuit point and is disposed longitudinally beside the tail portion of the first arm.

40. An antenna according to claim 39, wherein the second arm of the radiator comprises a meander-shape.

41. An antenna according to claim 40, wherein the second arm of the radiator comprises a serial coil so as to increase electric length and thus reduce the size of the antenna.

42. An antenna according to claim 36, further comprising a matching circuit disposed between an antenna port of the radio device and the feed point.

43. An antenna according to claim 42, wherein the matching circuit and the radiator together comprise a third resonance.

44. An antenna according to claim 43, wherein the matching circuit comprises a conductor pattern on a surface of a circuit board (PCB) of the radio device.

45. An antenna according to claim 36, wherein the radiator comprises of conductive coating of a dielectric plate which is supported at a height from the surface of a circuit board of the radio device.

46. An antenna according to claim 36, wherein said operating band is proximate a frequency of 0.9 GHz.

47. An antenna according to claim 46, further comprising a second radiator with a corresponding second feed point, the second radiator being capable of radiating in a second operating band having a frequency higher than said operating band.
